(19) United States
(12) Patent Application Publication
(10) Pub. No.: US 2010/0006003 A1
(43) Pub. Date: Jan. 14, 2010

(54) COATING, ADHESIVE, AND IMPREGNATING SUBSTANCE, PARTICULARLY AS A CONSTRUCTION AND RESTORATION MATERIAL

(76) Inventors: Adalbert Zinck, Isny (DE); Peter Riebling, Lindau/B. (DE); Zoltan Boldizsar, Isny/Aligau (DE)

Correspondence Address: DOBRUSIN & THENNISCH PC, 29 W LAWRENCE ST, SUITE 210, PONTIAC, MI, 48342, US

(21) Appl. No.: 12/438,620

(22) PCT Filed: Aug. 22, 2007
(86) PCT No.: PCT/EP2007/007368

§ 371 Date: May 13, 2009

(30) Foreign Application Priority Data
Aug. 31, 2006 (DE) 20 2006 013 438.7

(51) Int. Cl. C08L 91/06; C08L 97/02

(52) U.S. Cl. 106/137.1; 106/270

(57) ABSTRACT

The invention relates to a coating, adhesive, and impregnating substance (“Punic Milk”), particularly as a construction and restoration material, comprising a so-called “Punic Wax,” having at least beeswax, potash (K₂CO₃), and water (H₂O), and optionally honey/sugar, and optionally borax casein, wherein the coating, adhesive, and impregnating substance further comprises sodium silicate (Na₂SiO₂). This results in the advantage that the known “Punic Wax” is provided with relatively high adhesion properties by the addition of sodium silicate (Na₂SiO₂) and in addition becomes fire-resistant to non-flammable, which can be further amplified by means of the optional addition of honey/sugar and borax casein.

The invention relates to a coating, bonding and impregnating composition, particularly as a construction and restoration material, in the form of an improved formula of the so-called “Punic Wax”, already known from antiquity, in accordance with the preamble of independent claim 1.

This ancient “Punic Wax” is a kind of “soda wax lime soap”, produced from beeswax which has been boiled with seawater. It has been used as a paint binder for painting and for marine coating.

A similar formula of recent times for “Punic Wax”, from Kreidezeit Naturfarben GmbH, D-31196 Sehlem, is based on a beeswax, which is melted, purified and then bleached using activated carbon and fuller's earth. This wax bleached in this way is subsequently saponified with potash and so made partly water-soluble, making it easy to spread and to apply by spatula. This modern “Punic Wax” is used for painting, stuccowork and restoration.

Patent specification AT-376999 describes a process for preparing Punic Wax from desert and steppe grass, whereby yellow wax dust from these grasses is boiled in saturated brine with addition of powdered soda (steppe salt lake alkalis), then the porridgey material deposited like a foam at the surface is scooped off and quenched in cold water, after which the wax cake present is purified by being boiled at least once in water containing iron oxide and cooled in pure water, and then is bleached in the sun, the wax thus purified and bleached being subjected to reactive burning with iron catalysts, e.g. iron filings, and held at a temperature of about 300° C. for about 3 hours, after which the wax, cooled and freed from the catalyst by boiling in water, is again exposed to solar bleaching.

The term “Punic Wax”, accordingly, is not defined by any clear formula. The known “Punic Wax”, however, is composed primarily of beeswax, which is hardened by corresponding processes, it being possible for this hardening process to include boiling in seawater, saponification with powdered soda or potash, and addition of water.

DE 199 59 510 A1 relates to a plant treatment composition which is also used for preventing and treating fungal infestation in crop plants, with the following fungicidal composition:

1. salts of glycolate, palmitate or stearate or combinations thereof;

2. lecithin, which is a phosphoglyceride and acts as an emulsifier, and contains a glycerol complex (alcohol), and may also contain a palmitic acid radical;

3. sodium silicate (Na₂SiO₂);

4. potassium carbonate (K₂CO₃), which is also known by the name “potash”.

Diluted with water, these salts form an ester product of acid and alcohol, such as wax, for example, which could be animal, plant or synthetic in origin. Any more precise description in this respect, however, is lacking entirely.

The known “Punic Wax”, however, is associated with the disadvantage that it has only relatively poor adhesion properties and, moreover, is readily combustible, and hence is not suitable, or is of only limited suitability, as a coating, bonding and impregnating composition, particularly as a construction and restoration material.

It is an object of the present invention to develop a coating, bonding and impregnating composition, particularly as a construction and restoration material, in such a way that it has improved adhesion properties and also is incombustible or highly incombustible.

The achievement of this object is served by the features of independent claim 1.

It is essential here that the coating, bonding and impregnating composition (also called “Punic Milk” below) comprises “Punic Wax” composed at least of beeswax, potash (K₂CO₃) and water (H₂O), and also sodium silicate (Na₂SiO₂).

This produces the essential advantage that, as a result, the “Punic Wax” known per se, as a result of addition of sodium silicate (Na₂SiO₂), acquires relatively high adhesion properties and, moreover, becomes fire-resistant to incombustible.

A formula which has proven particularly preferable for the base constituent of the “Punic Wax” is the following:

Yellow beeswax (unbleached), potash (K₂CO₃), water, especially distilled or softened (or else cleaned, low-lime rainwater), and also honey solution and/or sugar solution.

Beeswax, as the major constituent of the Punic Wax, contains, in addition to long-chain alcohols and acids, free cerotinic acid, melissic acid and similar acids as constituents, and also saturated hydrocarbons, alcohols and other substances, such as flavors that are specific to the species of bee, for example.

Honey contains 80% sugar, 19% water, 1% wax, dye and enzymes, which gives the Punic Wax enormous adhesive bonding capacity and strength.

Example of Preferred Proportions:

1 kg yellow pure beeswax

100 g potash, dissolved in 0.5 liter of hot distilled water or clean rainwater

0.5 liter hot honey solution and/or sugar solution with

100 g of honey and/or sugar,

all diluted with 3 liters of distilled water or clean rainwater

Example of a Preferred Preparation Process:

1 kg of yellow beeswax is melted on a cooktop in a pot with a capacity of at least 10 liters. When the beeswax is liquid and hot, the half liter of dissolved potash, also hot, is added slowly with stirring. The potash solution must only ever be added in small quantities, and the composition, which is now slightly foamy, must be stirred continually. If the potash is added rapidly, there is a risk of excessive foaming. Following stirred incorporation, the honey solution and/or sugar solution is then stirred in, in a hot condition. Thereafter, cold water is incorporated into the hot wax material. Dilution must be accompanied by continual stirring. After further brief heating, the pot is covered with a lid and set down for cooling. It is advantageous to carry out occasional stirring of the resulting “Punic Wax” of top quality during the cooling process. As a creamy substance, it can now be dispensed into vessels that can be given an airtight seal. Sealed in an airtight manner, the “Punic Wax” keeps for about 2 to 3 years if stored under cool conditions.

From this “Punic Wax”, prepared as described above, the “Punic Milk” of the invention, with preferred proportions, is then prepared:

### EXAMPLE 1

⅛ liter dilute creamy “Punic Wax”, prepared as described above;

⅛ liter distilled water or clean rainwater, in which additionally a tablespoon of honey and/or sugar has been dissolved;

¾ liter sodium silicate (Na₂SiO₂)

### EXAMPLE 2

¼ liter dilute creamy “Punic Wax”, prepared as described above;

¼ liter distilled water or clean rainwater;

¼ liter liquid borax casein, i.e. sodium tetraborate (Na₂B₄O₇·10 H₂O) with milk proteins and/or quark proteins

1¼ liter sodium silicate (Na₂SiO₂)

After thorough shaking, the “Punic Milk” of the invention is ready to use. Stored under cool conditions and in well-sealed plastic bottles, the “Punic Milk” of the invention from Example 1 can be kept for at least 1 year; that of Example 2, with borax casein, can be kept for about 3 months, but for weathering influences is even more resistant than without borax casein.

This “Punic Milk” of the invention is odorless, relatively non-irritant, and above all is nonflammable.

Modes of use:

1. The “Punic Milk” of the invention can be used, with dry pigments, to produce a wide variety of fire protection paints. The paints become particularly hard and adhere outstandingly to a wide variety of materials such as wood, cardboard, stone, plaster and all paintable substrates.

2. The “Punic Milk” of the invention solidifies rotten and soft wood by sinking in or injection, and so is particularly suitable for restorers as well. The “Punic Milk” of the invention can be used for wood restoration and stone sculptures. In the case of flaking, on a marble statue for example, both minor and major damage can be corrected readily using marble sand. With the “Punic Milk” of the invention, the sand paste acquires very good adhesion and hardness. Subsequent polishing is a further possibility.

3. The “Punic Milk” of the invention makes it possible to produce incombustible construction material. Wall linings, produced from sawdust, chips, all varieties of sand, marble flours, paper wastes and even dried hay can be realized. All base materials can be mixed with one another with no problems: for example, sawdust with quartz sand. Both materials together, along with the “Punic Milk” of the invention, in a ratio of 1:1 produce an incombustible new construction material which is of interest.

4. As a result of the outstanding universal bond strength, the “Punic Milk” of the invention can be employed in a large region of the Fine Arts (fine-art artists and art teachers). In painting, in the design of reliefs with different materials, and in wood design, this composition produces unimagined possibilities. From inexpensive waste products it is possible to create new materials and works. As a result of the ease of handling, it is also an ideal new material for schools.

5. The “Punic Milk” of the invention is suitable for pressure impregnation for construction-grade wood. The wood thus impregnated is, as a result, no longer flammable, or extremely nonflammable. Roof structures of old houses that are subject to preservation orders acquire essential protection by multiple treatment with the “Punic Milk” of the invention—this also relates to the infestation of construction-grade wood by insects.

1. A coating, bonding and impregnating composition (or alternatively “Punic Milk”), particularly as a construction and restoration material, comprising “Punic Wax” composed at least of beeswax, potash (K₂CO₃) and water (H₂O), characterized in that the coating, bonding and impregnating composition further comprises sodium silicate (Na₂SiO₂).

2. The coating, bonding and impregnating composition of claim 1, characterized in that the coating, bonding and impregnating composition further comprises honey and/or sugar which has been admixed to the “Punic Wax” in the form of a honey solution and/or sugar solution.

3. The coating, bonding and impregnating composition of claim 1, characterized in that the coating, bonding and impregnating composition further comprises borax casein, i.e. sodium tetraborate (Na₂B₄O_{7·10 H}₂O) with milk proteins and/or quark proteins, which has been admixed to the completed “Punic Wax”.

4. The coating, bonding and impregnating composition of claim 1, characterized in that the beeswax of the “Punic Wax” is unbleached, yellow beeswax.

5. The coating, bonding and impregnating composition of claim 2, characterized in that the “Punic Wax” is composed of 1 kg of yellow pure beeswax, 100 g of potash, dissolved in 0.5 liter of hot distilled water or clean rainwater, 0.5 liter of hot honey solution and/or sugar solution with 100 g of honey and/or sugar, all diluted with 3 liters of distilled water or clean rainwater.

6. The coating, bonding and impregnating composition of claim 5, characterized in that the coating, bonding and impregnating composition, i.e. the “Punic Milk”, is composed of ⅛ liter of dilute creamy “Punic Wax”, ⅛ liter of distilled water or clean rainwater, in which additionally a tablespoon of honey and/or sugar has been dissolved, and ¾ liter of sodium silicate (Na₂SiO₂).

7. The coating, bonding and impregnating composition of claim 5, characterized in that the coating, bonding and impregnating composition, i.e. the “Punic Milk”, is composed of ¼ liter of dilute creamy “Punic Wax”, ¼ liter of distilled water or clean rainwater, ¼ liter of liquid borax casein (Na₂B₄O₇·10 H₂O with milk proteins and/or quark proteins), 1.25 liter of sodium silicate (Na₂SiO₂).

8. The coating, bonding and impregnating composition of claim 1, characterized in that the coating, bonding and impregnating composition comprises one or any combination of color pigments, sand, sawdust, woodchips, rock flours, paper, cardboard or plant constituents.

9. The coating, bonding and impregnating composition of claim 8, characterized in that the coating, bonding and impregnating composition comprises sawdust and also quartz sand, in a ratio of 1:1.

10. The coating, bonding and impregnating composition of claim 1, characterized in that the water of the “Punic Wax” and/or of the “Punic Milk” is distilled water and/or rainwater which has been cleaned of solids.

11. The coating, bonding and impregnating composition of claim 2, characterized in that the coating, bonding and impregnating composition further comprises borax casein, i.e. sodium tetraborate (Na₂B₄O₇·10 H₂O) with milk proteins and/or quark proteins, which has been admixed to the completed “Punic Wax”.

12. The coating, bonding and impregnating composition of claim 11, characterized in that the coating, bonding and impregnating composition comprises one or any combination of color pigments, sand, sawdust, woodchips, rock flours, paper, cardboard or plant constituents.

13. The coating, bonding and impregnating composition of claim 12, characterized in that the coating, bonding and impregnating composition comprises sawdust and also quartz sand in a ratio of 1:1.

14. The coating, bonding and impregnating composition of claim 13, characterized in that the beeswax of the “Punic Wax” is unbleached, yellow beeswax.

15. The coating, bonding and impregnating composition of claim 4, characterized in that the coating, bonding and impregnating composition further comprises borax casein, i.e. sodium tetraborate (Na₂B₄O₇·10 H₂O) with milk proteins and/or quark proteins, which has been admixed to the completed “Punic Wax”.

16. The coating, bonding and impregnating composition of claim 15, characterized in that the coating, bonding and impregnating composition comprises one or any combination of color pigments, sand, sawdust, woodchips, rock flours, paper, cardboard or plant constituents.

17. The coating, bonding and impregnating composition of claim 16, characterized in that the coating, bonding and impregnating composition comprises sawdust and also quartz sand in a ratio of 1:1.
